(19) United States
(12) Patent Application Publication
(10) Pub. No.: US 2026/0213842 A1
(43) Pub. Date: Jul. 23, 2026

(54) DISPERSION MANAGED TRANSCEIVER, MODULATOR AND DISPERSION COMPENSATION METHOD

(71) Applicant: Linktel Technologies, Inc., Milpitas, CA (US)

(72) Inventors: Chi Jim WU, Milpitas, CA (US); Linke LI, Milpitas, CA (US); Tianshu WU, Milpitas, CA (US); Ming XIAO, Milpitas, CA (US); Xianwen YANG, Milpitas, CA (US); Jian ZHANG, Milpitas, CA (US)

(73) Assignee: Linktel Technologies, Inc., Milpitas, CA (US)

(21) Appl. No.: 19/026,490

(22) Filed: Jan. 17, 2025

(51) Int. Cl. H04B 10/2507; G02B 6/293; G02F 1/21; H04B 10/40

(52) U.S. Cl. CPC H04B 10/2507; G02B 6/29358; G02F 1/212; H04B 10/40

(57) ABSTRACT

The provided is a dispersion managed transceiver, including digital signal processor (DSP) and receiver, the receiver is integrated with self-locking dispersion management device (DMD), the dispersion management device performs dispersion compensation on the optical path based on the signal-to-noise ratio (SNR) or bit error rate reading of the digital signal processor. And also provides a modulator, includes the above-mentioned transceiver. And also provides a dispersion compensation method for the transceiver, including the following steps: S1, integrating self-locking dispersion management device in receiver; S2, achieving self-locking of the optical path based on the signal-to-noise ratio or bit error rate reading from the digital signal processor, and compensating the dispersion of the optical path; S3, after compensation, counteracting different fiber chromatic dispersion values from different fiber lengths. The dispersion managed transceiver has integrated dispersion management device in receiver side with self-locking function.

### TECHNICAL FIELD

The present invention relates to the optical communication technology field, specifically, to a dispersion managed transceiver and its dispersion compensation method.

### BACKGROUND

With the ever-growing transmission data rate in data center, the restriction of fiber dispersion is becoming more and more serious. In most popular CWDM4 system, when bit rate increased to 200G/lane, the group delay of 1271nm and 1331nm caused by chromatic dispersion of 10km fiber is comparable to signal period of 10ps, which will seriously impact the system. The supported reach estimated is less than 2km at 200G/lane and will go down to 500m at 400G/lane with standard EML.

Tighten the channel spacing from CWDM to LWDM is a common way to avoid fiber dispersion. But that will increase FWM impairment. And the compatibility with existed CWDM product is another concern.

A Mach Zehnder modulator (MZM) with ideal chirp management is one solution for longer reach. However, the chirp achieved by unequal splitting ratio will degrade the RF performance, which limits the application.

### SUMMARY

One purpose of the present invention is to provide a transceiver with dispersion management and its dispersion compensation method. At least it can solve some of the defects in existing technology.

To achieve the above objectives, the embodiment of the present invention provides the following technical solution: a dispersion managed transceiver, comprising digital signal processor (DSP) and receiver, the receiver is integrated with self-locking dispersion management device (DMD), the dispersion management device performs dispersion compensation on the optical path based on the signal-to-noise ratio (SNR) or bit error rate reading of the digital signal processor.

Further, the dispersion management device includes single-cavity silicon etalon chip, the incident side of the single-cavity silicon etalon chip is coated with adjustable reflective coating, and the exit side of the single-cavity silicon etalon chip is coated with high reflective coating.

Further, the single-cavity silicon etalon chip is integrated with heating component for thermal tuning.

Further, the heating component includes heater and thermistor.

Further, the dispersion management device also includes supporting optic for supporting the single-cavity silicon etalon chip.

Further, the supporting optic includes first prism and second prism, the first prism and the second prism cooperate to support the single-cavity silicon etalon chip, the first prism has first incident surface and first reflective surface, the second prism has second reflective surface and second exit surface, the input light is transmitted to the first reflective surface through the first incident surface, and the first reflective surface reflects the light to the single-cavity silicon etalon chip, the single-cavity silicon etalon chip reflects the light back to the second reflective surface, and the second reflective surface emits the output light through the second exit surface.

Further, the first prism and the second prism are symmetrically arranged with the vertical center line as the symmetry axis.

Further, the receiver also includes a demultiplexer, in the multiple optical signals after demultiplexing by the demultiplexer, the two optical signals at the edge are equipped with the dispersion management device.

Another embodiment of the present invention provides the following technical solution: a modulator, includes the above-mentioned transceiver, wherein the modulator is Electro Absorption (EA) Modulator or Mach-Zehnder (MZ) Modulator.

Another embodiment of the present invention provides the following technical solution: a dispersion compensation method for the transceiver, the method is used for the above-mentioned transceiver, comprising the following steps:

S1, integrating self-locking dispersion management device in receiver;

S2, achieving self-locking of the optical path based on the signal-to-noise ratio or bit error rate reading from the digital signal processor, and compensating the dispersion of the optical path;

S3, after compensation, counteracting different fiber chromatic dispersion values from different fiber lengths.

Compared with the prior art, the invention has the following beneficial effects:

The dispersion managed transceiver has integrated dispersion management device in receiver side with self-locking function. That helps the 200G/lane CWDM4 system breakthrough the limitation of fiber chromatic dispersion, and extend the reach from 2km to 10km. This dispersion compensation method has low cost, low power consumption, and does not sacrifice RF performance.

### BRIEF DESCRIPTION OF THE DRAWINGS

FIG. 1 is a schematic diagram of the dispersion managed transceiver provided in an embodiment of the present invention;

FIG. 2 is a schematic diagram of the dispersion management device for the dispersion managed transceiver provided in an embodiment of the present invention;

FIG. 3 is a schematic diagram of the coating of the single-cavity silicon etalon chip of the dispersion management device for the dispersion managed transceiver provided in an embodiment of the present invention;

FIG. 4 shows a schematic diagram of the tested EML spectrum at 106GBaud PAM4 (solid) and simulated dispersion spectrum of DMD (dash) of the dispersion managed transceiver provided by an embodiment of the present invention;

FIG. 5 is a schematic diagram of the supporting optic of the dispersion management device for the dispersion managed transceiver provided in an embodiment of the present invention.

In the drawings, 1 is the receiver, 2 is the transmitter, 3 is the digital signal processor, 4 is the transimpedance amplifier, 5 is the demultiplexer, 6 is the single-cavity silicon etalon chip, 7 is the heater, 8 is the thermistor, 9 is the supporting optic, 10 is the temperature control circuit, 11 is the high reflective coating, 12 is the adjustable reflective coating, 13 is the first prism, 14 is the second prism, 15 is the first incident surface, 16 is the first reflective surface, 17 is the second reflective surface, 18 is the second exit surface.

### DETAILED DESCRIPTION OF THE EMBODIMENTS

The following will provide a clear and complete description of the technical solution in the embodiments of the present invention, in conjunction with the accompanying drawings. Obviously, the described embodiments are only a part of the embodiments of the present invention, not all of them. Based on the embodiments in the present invention, all other embodiments obtained by ordinary technicians in the art without creative labor fall within the scope of protection of the present invention.

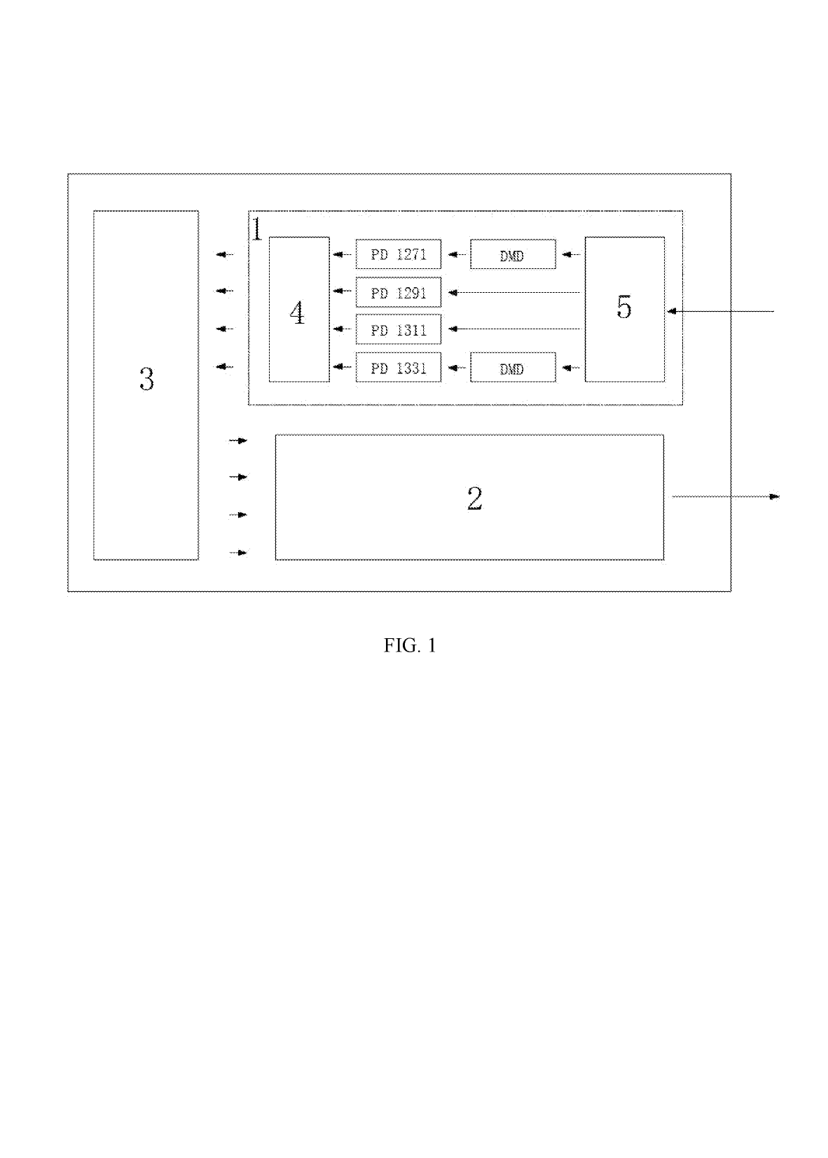

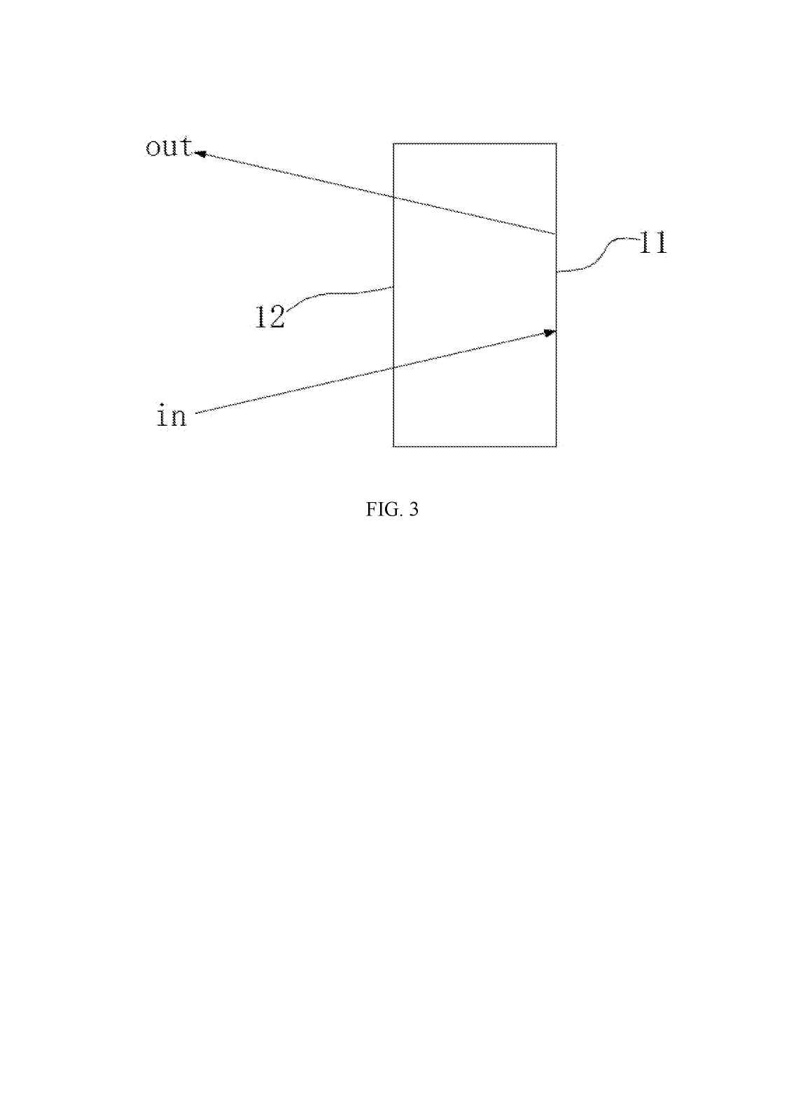

Refer to FIGS. 1 to 5, an embodiment of the present invention provides a dispersion managed transceiver, comprising digital signal processor 3 and receiver 1, characterized in that, the receiver 1 is integrated with self-locking dispersion management device, the dispersion management device performs dispersion compensation on the optical path based on the signal-to-noise ratio or bit error rate reading of the digital signal processor 3. In this embodiment, the dispersion managed transceiver has integrated dispersion management device in receiver side with self-locking function. That helps the 200G/lane CWDM4 system breakthrough the limitation of fiber chromatic dispersion, and extend the reach from 2km to 10km. This dispersion compensation method has low cost, low power consumption, and does not sacrifice radio frequency performance.

Specifically, the dispersion management device used in this transceiver integrates a self-locking dispersion management device on the light receiving component side, which helps the transceiver to counteract different fiber chromatic dispersion values from different fiber lengths. TX wavelength shift issue will be solved with this self-locking function, as the DMD will change chromatic dispersion value to match incoming wavelength to achieve best SNR.

Among them, the self-locking is based on the signal-to-noise ratio or bit error rate reading of the digital signal processing processor 3 ( DSP ) as a decision to adjust the temperature of the dispersion management device, so that the module works at the best performance point. Due to the real-time reading of signal-to-noise ratio or bit error rate during module operation, the temperature of the dispersion management device can be optimized in real-time, allowing the module to find the optimal operating point of the dispersion management device and cope with various system changes such as temperature changes, wavelength drift, fiber switching, etc.

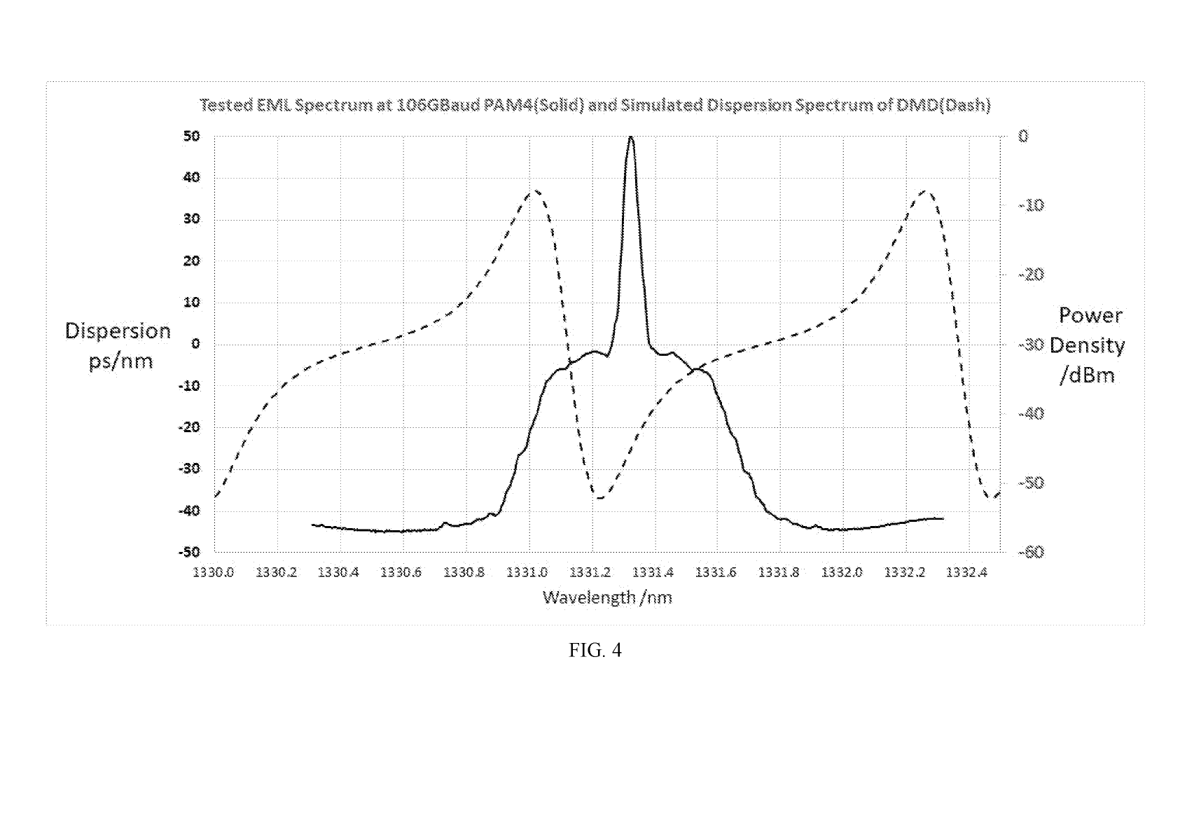

Refer to FIGS. 1,2,3, and 5, refine the dispersion management device mentioned above, the dispersion management device includes single-cavity silicon etalon chip 6, the incident side of the single-cavity silicon etalon chip 6 is coated with adjustable reflective coating 12, and the exit side of the single-cavity silicon etalon chip 6 is coated with high reflective coating 11. The reflectivity of the high reflection coating 11 is greater than 99%, while the adjustable range of the adjustable reflective coating 12 is between 0 and 100%. The single-cavity silicon etalon chip 6 can works as GT-etalon for dispersion compensation without optical power loss. An exemplary Etalon design for 200G/lane 10km application shown in FIG. 4. The dispersion spectrum of DMD has peak dispersion of ±38ps/nm and FSR of 200GHz. The dispersion spectrum can be thermally tuned with a sensitivity of 14GHz/deg, to align with the laser spectrum for various dispersion compensation values. For edge channel of 1330nm, DMD is tuned to provide a negative dispersion to compensate 10km fiber dispersion of 25ps/nm. For another edge channel of 1270nm, DMD is tuned to provide positive dispersion to compensate 10km fiber dispersion of -40ps/nm. The flat dispersion area between peak and value is used for short reach 0-2km.

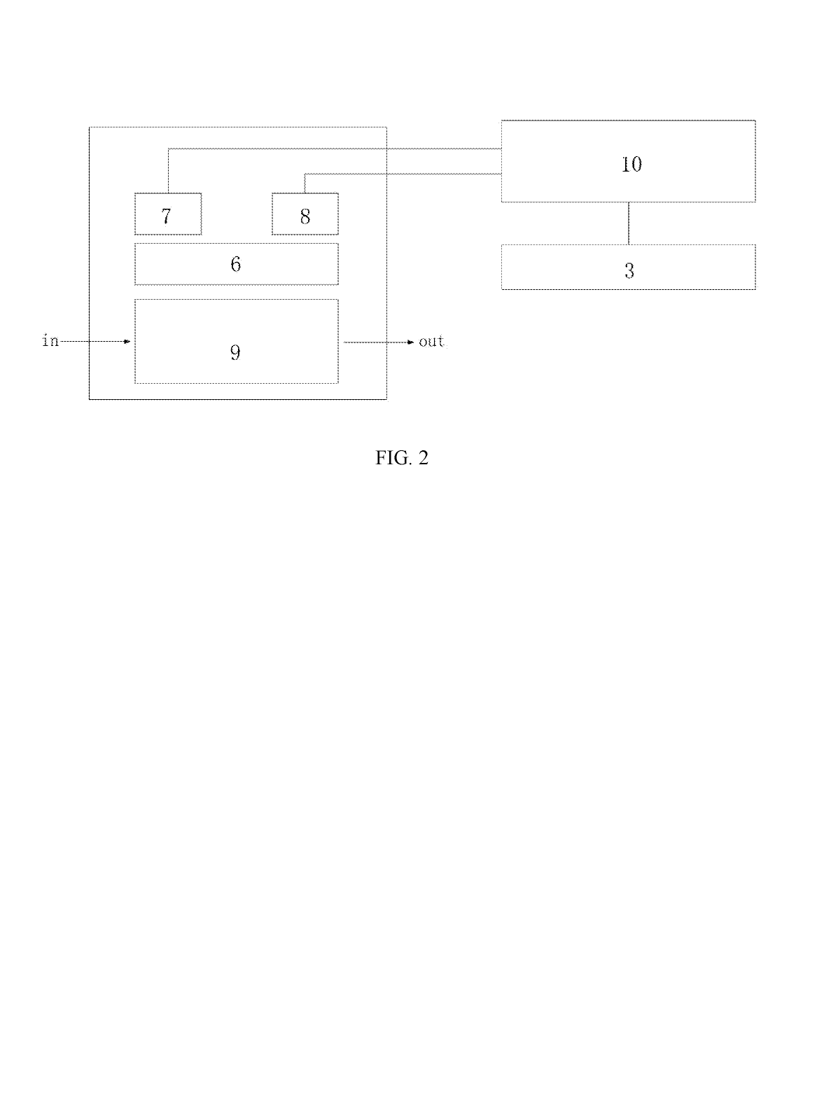

Further refine the dispersion management device mentioned above, refer to FIG. 2, the single-cavity silicon etalon chip 6 is integrated with heating component for thermal tuning. The heating component includes heater 7 and thermistor 8. Preferred, the heater 7 and the thermistor 8 are electrically connected with the temperature control circuit 10 to control the temperature of the single-cavity silicon etalon chip 6.

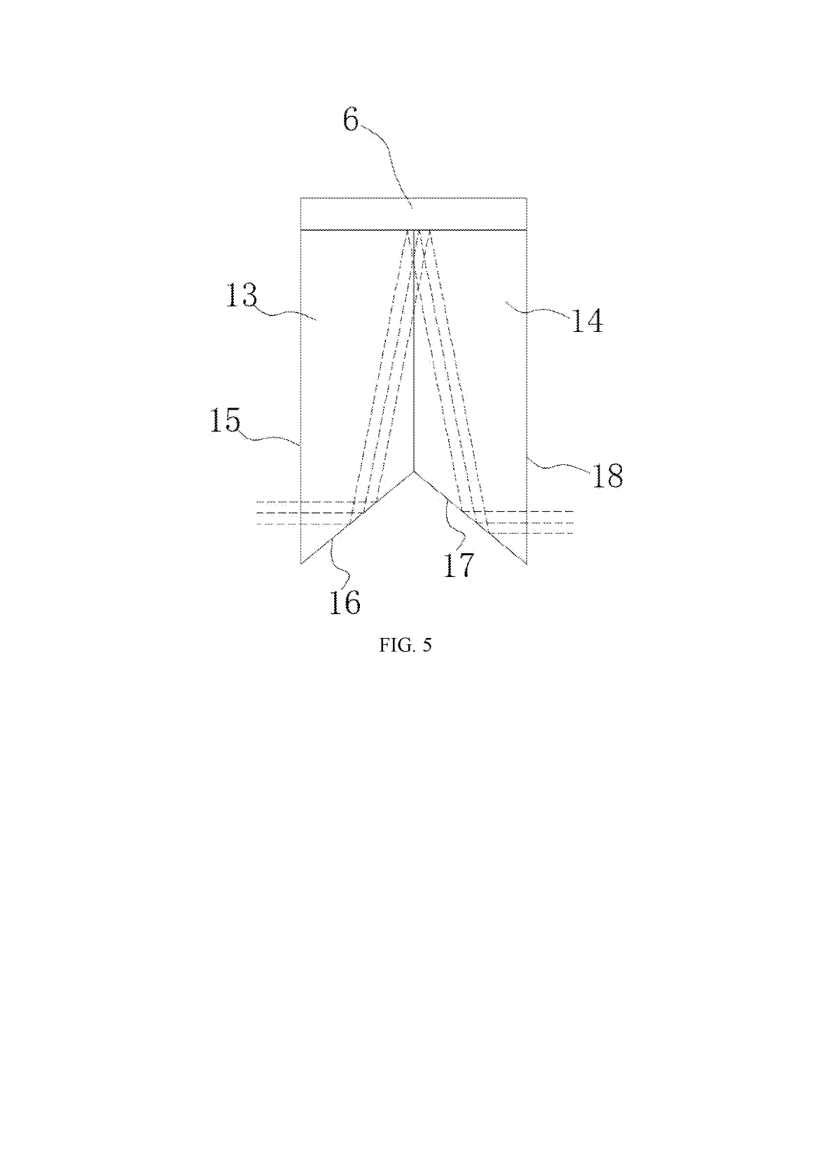

Further refine the dispersion management device mentioned above, refer to FIGS. 2 and 5, the dispersion management device also includes supporting optic 9 for supporting the single-cavity silicon etalon chip 6. The supporting optic 9 is used as an auxiliary optical device to install the DMD into a small package of the transceiver. As shown in FIG. 5, refine the supporting optic 9, the supporting optic 9 includes first prism 13 and second prism 14, the first prism 13 and the second prism 14 cooperate to support the single-cavity silicon etalon chip 6, the first prism 13 has first incident surface 15 and first reflective surface 16, the second prism 14 has second reflective surface 17 and second exit surface 18, the input light is transmitted to the first reflective surface 16 through the first incident surface 15, and the first reflective surface 16 reflects the light to the single-cavity silicon etalon chip 6, the single-cavity silicon etalon chip 6 reflects the light back to the second reflective surface 17, and the second reflective surface 17 emits the output light through the second exit surface 18. The light enters from the first incident surface 15 and is reflected to the single-cavity silicon etalon chip 6 by the first reflective surface 16, and then sent to the second reflective surface 17 by the single-cavity silicon etalon chip 6. Finally, it is reflected from the second reflection surface 17 to the second exit surface 18, and then emitted from the dispersion management device. In the supporting optic 9, total internal reflection (TIR) is performed through the first reflective surface 16 and the second reflective surface 17. Preferred, the first prism 13 and the second prism 14 are symmetrically arranged with the vertical center line as the symmetry axis. Preferred, AR coating can be applied on the first incident surface 15 and the second exit surface 18. The AR coating is the anti reflective coating.

Refer to FIG. 1, the receiver 1 also includes a demultiplexer 5, in the multiple optical signals after demultiplexing by the demultiplexer 5, the two optical signals at the edge are equipped with the dispersion management device. Preferably, the number of dispersion management devices on each optical signal can be selected as needed, such as 4, 3, or 1 dispersion management device required in certain specific scenarios. In this embodiment, the transceiver includes a standard digital signal processor 3, a standard CWDM transmitter 2 and a special CWDM receiver 1 with DMD. In typical 200G/lane CWDM4 application, signal coming to receiver will first be separated into four wavelength channels by DEMUX (demultiplexer 5). The two middle wavelength channels of 1291nm and 1311nm will go directly to Photo Diodes (PDs) without dispersion management, because the impacts of fiber dispersion are acceptable for the 200G/lane system. The other edge wavelength channels of 1331 and 1271nm, which suffer more serious fiber dispersion will have DMD before launching to PDs. The DMD is tuned according to SNR or BER reading from DSP.

Refer to FIG. 1, the transceiver keeps standard DSP and receiver 1 design, , only adds DMD in receiver side to counteract with fiber chromatic dispersion. The DMD can be tuned to provide various dispersion values from positive to negative. The DMD will self-lock with SNR or BER reading from DSP inside the transceiver, to adapt to different fiber length and wavelength.

Refer to FIGS. 1 to 5, the embodiment of the present invention provides a modulator, includes the above-mentioned transceiver, wherein the modulator is an EA Modulator or an MZ Modulator. In this embodiment, the above-mentioned transceiver is suitable for EA modulators (single ended EML, differential EML) and MZ modulators (SiPh, TFLN, DMZ, etc.), and has great potential to be extended to 400G/lane.

Refer to FIGS. 1 to 5, the embodiment of the present invention provides a dispersion compensation method for the transceiver, the method is used for the above-mentioned transceiver, comprising the following steps:

S1, integrating self-locking dispersion management device in receiver 1;

S2, achieving self-locking of the optical path based on the signal-to-noise ratio or bit error rate reading from the digital signal processor 3, and compensating the dispersion of the optical path;

S3, after compensation, counteracting different fiber chromatic dispersion values from different fiber lengths.

In this embodiment, through the dispersion compensation method of the present invention, the 200G/lane CWDM4 system can breakthrough the limitation of fiber chromatic dispersion, and extend the reach from 2km to 10km. This dispersion compensation method has low cost, low power consumption, and does not sacrifice RF performance. The dispersion management device used in this transceiver integrates a self-locking dispersion management device on the light receiving component side, which helps the transceiver to counteract different fiber chromatic dispersion values from different fiber lengths. TX wavelength shift issue will be solved with this self-locking function, as the DMD will change chromatic dispersion value to match incoming wavelength to achieve best SNR.

As shown in FIG. 4, The dash line represents the dispersion spectrum of DMD, and the solid line represents the spectrum of the optical signal. The dispersion of DMD is periodic, with both positive and negative values. The spectral position can be adjusted by temperature (left-right shift) to match the wavelength of the optical signal. Specifically, by adjusting the left or right shift of the dispersion spectral line shown by the dash line, the spectral line shown by the solid line will receive different dispersion compensation. The spectrum of the optical signal does not change, but only undergoes dispersion compensation, which is at the phase level. The current state of FIG. 4 is that the spectral line shown by the solid line is getting negative dispersion compensation. At this time, most of the signal falls in the negative dispersion region of the dispersion spectrum of the DMD, and negative dispersion compensation is brought in to deal with the positive dispersion fiber effect of the fiber in the 1330 band. If the temperature of DMD is changed, the positive dispersion of the dispersion spectrum of the DMD can also be aligned to the signal, and the positive dispersion compensation can be performed to deal with the negative dispersion of the fiber in the 1270 band. When adjusting, if you want to provide negative dispersion compensation, you can move the dispersion spectrum line shown by the dash line so that most of the solid line falls within the negative range. If you want to provide positive dispersion compensation, move the dispersion spectrum line shown by the dash line so that most of the solid line falls within the positive range. When adjusting, if negative dispersion compensation is required, the dispersion spectrum line shown by the dash line can be moved so that most of the solid line falls within the negative range. If positive dispersion compensation is required, the dispersion spectrum line shown by the dash line can be moved so that most of the solid line falls within the positive range. The adjustment of the dash line is dynamic, and the dispersion compensation is not a constant value, it is necessary to find a suitable compensation value through self-locking.

The above embodiments are only illustrative of the present invention and not intended to limit the same, a person skilled in the art can also make various changes and modifications without departing from the spirit and scope of the present invention, thus all equivalent technical solutions are within the scope of the present invention, the protection scope of the patent invention is limited by the appended claims.

What is claimed is:

1. A dispersion managed transceiver, comprising digital signal processor and receiver, wherein the receiver is integrated with a self-locking dispersion management device, the self-locking dispersion management device performs dispersion compensation on an optical path based on a signal-to-noise ratio or bit error rate reading of the digital signal processor.

2. The dispersion managed transceiver according to claim 1, wherein the self-locking dispersion management device comprises a single-cavity silicon etalon chip, an incident side of the single-cavity silicon etalon chip is coated with adjustable reflective coating, and an exit side of the single-cavity silicon etalon chip is coated with high reflective coating.

3. The dispersion managed transceiver according to claim 2, wherein the single-cavity silicon etalon chip is integrated with heating component for thermal tuning.

4. The dispersion managed transceiver according to claim 3, wherein the heating component comprises heater and thermistor.

5. The dispersion managed transceiver according to claim 2, wherein the self-locking dispersion management device further comprises supporting optic for supporting the single-cavity silicon etalon chip.

6. The dispersion managed transceiver according to claim 5, wherein the supporting optic comprises first prism and second prism, the first prism and the second prism cooperate to support the single-cavity silicon etalon chip, the first prism has first incident surface and first reflective surface, the second prism has second reflective surface and second exit surface, input light is transmitted to the first reflective surface through the first incident surface, and the first reflective surface reflects the light to the single-cavity silicon etalon chip, the single-cavity silicon etalon chip reflects the light back to the second reflective surface, and the second reflective surface emits output light through the second exit surface.

7. The dispersion managed transceiver according to claim 6, wherein the first prism and the second prism are symmetrically arranged with a vertical center line as a symmetry axis.

8. The dispersion managed transceiver according to claim 1, wherein the receiver further comprises demultiplexer, in a plurality of optical signals after demultiplexing by the demultiplexer, two optical signals at an edge are equipped with the self-locking dispersion management device.

9. A modulator, wherein the modulator comprises the dispersion managed transceiver according to claim 1, wherein the modulator is electro absorption (EA) modulator or Mach-Zehnder (MZ) modulator.

10. A dispersion compensation method for a transceiver, wherein the dispersion compensation method is configured for the transceiver according to claim 1, comprising the following steps:
S1, integrating the self-locking dispersion management device in the receiver;
S2, achieving self-locking of the optical path based on the signal-to-noise ratio or bit error rate reading from the digital signal processor, and compensating a dispersion of the optical path;
S3, after compensation, counteracting different fiber chromatic dispersion values from different fiber lengths.

11. The modulator according to claim 9, wherein in the dispersion managed transceiver, the self-locking dispersion management device comprises a single-cavity silicon etalon chip, an incident side of the single-cavity silicon etalon chip is coated with adjustable reflective coating, and an exit side of the single-cavity silicon etalon chip is coated with high reflective coating.

12. The modulator according to claim 11, wherein in the dispersion managed transceiver, the single-cavity silicon etalon chip is integrated with heating component for thermal tuning.

13. The modulator according to claim 12, wherein in the dispersion managed transceiver, the heating component comprises heater and thermistor.

14. The modulator according to claim 11, wherein in the dispersion managed transceiver, the self-locking dispersion management device further comprises supporting optic for supporting the single-cavity silicon etalon chip.

15. The modulator according to claim 14, wherein in the dispersion managed transceiver, the supporting optic comprises first prism and second prism, the first prism and the second prism cooperate to support the single-cavity silicon etalon chip, the first prism has first incident surface and first reflective surface, the second prism has second reflective surface and second exit surface, input light is transmitted to the first reflective surface through the first incident surface, and the first reflective surface reflects the light to the single-cavity silicon etalon chip, the single-cavity silicon etalon chip reflects the light back to the second reflective surface, and the second reflective surface emits output light through the second exit surface.

16. The modulator according to claim 15, wherein in the dispersion managed transceiver, the first prism and the second prism are symmetrically arranged with a vertical center line as a symmetry axis.

17. The modulator according to claim 9, wherein in the dispersion managed transceiver, the receiver further comprises demultiplexer, in a plurality of optical signals after demultiplexing by the demultiplexer, two optical signals at an edge are equipped with the self-locking dispersion management device.

18. The dispersion compensation method according to claim 10, wherein in the dispersion managed transceiver, the self-locking dispersion management device comprises a single-cavity silicon etalon chip, an incident side of the single-cavity silicon etalon chip is coated with adjustable reflective coating, and an exit side of the single-cavity silicon etalon chip is coated with high reflective coating.

19. The dispersion compensation method according to claim 18, wherein in the dispersion managed transceiver, the single-cavity silicon etalon chip is integrated with heating component for thermal tuning.

20. The dispersion compensation method according to claim 19, wherein in the dispersion managed transceiver, the heating component comprises heater and thermistor.
